(19) United States
(12) Patent Application Publication
(10) Pub. No.: US 2022/0205117 A1
(43) Pub. Date: Jun. 30, 2022

(54) WATER ELECTROLYSIS CATALYST FOR FUEL CELL ANODE, ANODE CATALYST COMPOSITION, AND MEMBRANE ELECTRODE ASSEMBLY

(71) Applicant: FURUYA METAL CO., LTD., Toshima-ku, Tokyo (JP)

(72) Inventors: Takashi ITO, Toshima-ku, Tokyo (JP); Hiroaki SUZUKI, Toshima-ku, Tokyo (JP)

(21) Appl. No.: 17/601,555

(22) PCT Filed: Apr. 3, 2020
(86) PCT No.: PCT/JP2020/015301

§ 371 Date: Oct. 5, 2021

(30) Foreign Application Priority Data
Apr. 12, 2019 (JP) 2019-076516

(51) Int. Cl. C25B 11/042; H01M 8/0656; C25B 1/04; H01M 4/92; H01M 8/1004; H01M 8/1018; C25B 9/17; H01M 4/88

(52) U.S. Cl. CPC C25B 11/042; H01M 8/0656; C25B 1/04; H01M 4/8807; H01M 8/1004; H01M 8/1018; C25B 9/17; H01M 4/926

(57) ABSTRACT

A water electrolysis catalyst containing a solid solution complex oxide of Ir and Ru, in which the solid solution complex oxide is represented by a chemical formula IrₓRu_{y}O₂ (where x and y satisfy x+y=1.0); and the solid solution complex oxide has one diffraction maximum peak in a range of 2θ=66.10° or more and 67.00° or less in powder X-ray diffraction (Cu Kα).

### BACKGROUND

### 1. Field of the Disclosure

The present disclosure relates to a catalyst for an anode used in a polymer electrolyte fuel cell, and more particularly to a water electrolysis catalyst for an anode having excellent durability against voltage reversal (reverse potential), an anode catalyst layer containing the water electrolysis catalyst, and a polymer electrolyte fuel cell including the anode catalyst layer.

### 2. Discussion of the Background Art

In order to realize the upcoming hydrogen energy society, a fuel cell capable of providing a high power density has attracted attention as a stationary power source or a power source for automobiles, and development for practical use has been advanced. In particular, a polymer electrolyte fuel cell is suitable for fuel cell vehicle applications because the polymer electrolyte fuel cell is operated at normal temperature and can be frequently started and stopped. The polymer electrolyte fuel cell is formed by using a membrane electrode assembly (MEA) in which a polymer electrolyte membrane is sandwiched between an anode catalyst layer and a cathode catalyst layer, and stacking laminates in each of which the membrane electrode assembly is further sandwiched between gas diffusion layers respectively provided on an anode side and a cathode side and between separators respectively provided on these sides. The electrochemical reaction in a normal operating state of the polymer electrolyte fuel cell is as follows. That is, a fuel supplied to the anode side, typically hydrogen, is oxidized with a hydrogen oxidation reaction (HOR) catalyst of the anode to become protons and electrons (2H₂→4H⁺+4e⁻). The protons reach the cathode catalyst layer through the electrolyte membrane made of a cation exchange membrane in contact with the anode catalyst layer. On the other hand, the electrons generated at the anode reach the cathode catalyst layer from an electrically conductive gas diffusion layer in contact with the anode via the separator and an external circuit. An oxidant gas supplied to the cathode side, typically oxygen, reacts with the protons supplied via the electrolyte membrane and the electrons supplied via the external circuit on an oxygen reduction reaction (ORR) catalyst to generate water (O₂+4H⁺+4e⁻→2H₂O).

Such a fuel cell has a problem that when the anode side becomes insufficient in fuel for some reason, the fuel cell is brought into a voltage reversal (reverse potential) state, which is different from the above normal operating state, and in this case, extreme oxidation degradation of the anode catalyst layer that does not occur in the normal operating state occurs, resulting in deterioration of the performance and reliability of the fuel cell.

As a measure to prevent oxidation degradation of the anode due to such voltage reversal, a method of issuing an alarm of a reverse potential by monitoring the potential or monitoring anode exhaust gas, and performing a treatment such as stopping the system is adopted. On the other hand, as a measure to improve durability of the anode in the reverse potential state and as a measure to promote a water electrolysis reaction in the anode catalyst layer, known are a technique using an anode including a first composition for fuel oxidation and a second composition containing ruthenium oxide (RuO₂) or iridium oxide (IrO₂) that generates oxygen from water as a catalyst composition of the anode (see, for example, Patent Literature 1) and a technique using an anode catalyst in which platinum and iridium coexist and are supported on conductive carbon (see, for example, Patent Literature 2). In addition, Ioroi et. al. have recently published the results of a reverse potential durability test using an anode for a fuel cell in which iridium black is added to a platinum-supported conductive oxide catalyst (see, for example, Non Patent Literature 1).

### CITATION LIST

### Patent Literature

Patent Literature 1: JP 2003-508877 A
Patent Literature 2: JP 2011-040177 A
Patent Literature 3: JP 5283499 B
Patent Literature 4: JP 2006-236631 A
Patent Literature 5: JP 2-25994 B
Patent Literature 6: JP 5515019 B
Patent Literature 7: JP 5152942 B
Patent Literature 8: JP 6125580 B
Patent Literature 9: US 2007/0031722

### Non Patent Literature

Non Patent Literature 1: Tsutomu Ioroi, Kazuaki Yasuda, proceedings of the 59th Battery Symposium (November 2018, Osaka), lecture number: 1H23
Non Patent Literature 2: T. Ioroi et. al., Phys. Chem. Chem. Phy., 12, 7529 (2010)

### SUMMARY

### Technical Problem

However, according to the techniques of Patent Literatures 1 and 2, durability of the anode against reverse potential is still insufficient, and an anode having higher durability has been desired.

Therefore, an object of the present disclosure is to provide an anode catalyst composition having remarkably high durability against reverse potential as an anode catalyst composition for a polymer electrolyte fuel cell, and specifically, to provide a highly durable water electrolysis catalyst, an anode catalyst composition, and a membrane electrode assembly using the same for a fuel cell anode.

### Solution to Problem

As a result of intensive studies in view of the above circumstances, the present inventors have found that, in a composition of an anode catalyst, a solid solution complex oxide catalyst of ruthenium and iridium having a diffraction peak at 2θ=66.10° or more and 67.00° or less in powder X-ray diffraction (Cu Kα) is used as a second composition for generating oxygen from water, which is to be used by being dispersed and mixed with a first composition for fuel oxidation, thereby obtaining significantly higher durability than conventionally known iridium oxide (IrO₂) and ruthenium oxide (RuO₂), and have completed the present disclosure.

That is, according to this application, the following disclosure is provided.

A water electrolysis catalyst according to the present disclosure is a water electrolysis catalyst containing a solid solution complex oxide of Ir and Ru, in which the solid solution complex oxide is represented by a chemical formula IrₓRu_{y}O₂ (where x and y satisfy x+y=1.0); and the solid solution complex oxide has one diffraction maximum peak in a range of 2θ=66.10° or more and 67.00° or less in powder X-ray diffraction (Cu Kα).

In the water electrolysis catalyst according to the present disclosure, the solid solution complex oxide preferably has a composition further satisfying 0.2≤x≤0.5.

In the water electrolysis catalyst according to the present disclosure, a (1,1,0) crystallite size of the solid solution complex oxide determined by powder X-ray diffraction (Cu Kα) is preferably in a range of 1.0 nm to 10 nm.

In the water electrolysis catalyst according to the present disclosure, it is preferable that peaks derived from an IrO₂ phase and an RuO₂ phase are not observed by powder X-ray diffraction (Cu Kα).

The water electrolysis catalyst according to the present disclosure may contain iridium-ruthenium hydroxide.

An anode catalyst composition for a polymer electrolyte fuel cell according to the present disclosure is obtained by mixing the water electrolysis catalyst according to the present disclosure and a fuel oxidation catalyst.

In the anode catalyst composition for a polymer electrolyte fuel cell according to the present disclosure, it is preferable that the fuel oxidation catalyst is a catalyst in which platinum or a platinum alloy is supported on a conductive catalyst support, and the anode catalyst composition is obtained by mixing so that the added amount of the water electrolysis catalyst is 1% or more and 20% or less by mass with respect to an added amount of the platinum or the platinum alloy.

In the anode catalyst composition for a polymer electrolyte fuel cell according to the present disclosure, the conductive catalyst support is preferably a carbon powder catalyst support or a conductive oxide powder catalyst support.

In a membrane electrode assembly (MEA) for a polymer electrolyte fuel cell according to the present disclosure, a cation exchange membrane is sandwiched between a cathode catalyst layer having oxygen-reduction activity and an anode catalyst layer containing the anode catalyst composition according to the present disclosure.

In the membrane electrode assembly for a polymer electrolyte fuel cell according to the present disclosure, at least one of the cathode catalyst layer and the anode catalyst layer preferably contains a proton conductive ionomer.

### Advantageous Effects of Disclosure

The present disclosure can provide an anode catalyst composition having remarkably high durability against reverse potential as an anode catalyst composition for a polymer electrolyte fuel cell.

### BRIEF DESCRIPTION OF THE DRAWINGS

FIG. 1 is a diffraction spectrum image of water electrolysis catalysts IrₓRu_{y}O₂ in powder X-ray diffraction at 2θ=50° to 75°, and shows diffraction patterns of each of a catalyst E-1 of Example 1, a catalyst E-2 of Example 2, a catalyst E-4 of Comparative Example 1, and a catalyst E-5 of Comparative Example 2.

FIG. 2 is a graph showing results of reverse potential durability tests in single cells of fuel cells of an MEA-1 of Example 6-1, an MEA-2 of Example 6-2, an MEA-3 of Comparative Example 7-1, an MEA-4 of Comparative Example 7-2, and an MEA-5 of Comparative Example 7-3.

### DETAILED DESCRIPTION OF THE PREFERRED EMBODIMENT

Hereinafter, the present disclosure will be described in detail with reference to embodiments, but the present disclosure is not construed as being limited to these descriptions. The embodiment may be variously modified as long as the effect of the present disclosure is exhibited.

(1) The present embodiment is a water electrolysis catalyst that can be suitably used for a voltage reversal durable anode catalyst layer of a polymer electrolyte fuel cell, includes an IrₓRu_{y}O₂ type (where x and y satisfy x+y=1.0) having one diffraction maximum peak at 2θ=66.10° or more and 67.00° or less in powder X-ray diffraction (Cu Kα), and is preferably a solid solution complex oxide catalyst of Ir and Ru, having a composition satisfying 0.2≤x≤0.5.

(2) The present embodiment is the catalyst according to (1), in which a crystallite size of the solid solution complex oxide catalyst of Ir and Ru determined from the (1,1,0) diffraction peak at around 2θ=28° in powder X-ray diffraction is 1.0 nm to 10 nm. The catalyst is more preferably a catalyst having a crystallite size of 1.5 nm to 7.0 nm.

(3) Further, the present embodiment is an anode catalyst composition for a polymer electrolyte fuel cell including a fuel oxidation catalyst composed of a carbon-supported catalyst of platinum or a platinum alloy or a conductive oxide-supported catalyst of platinum or a platinum alloy, and the water electrolysis catalyst of (1) or (2).

(4) Further, the present embodiment is an anode catalyst composition for a polymer electrolyte fuel cell obtained by mixing so that an added amount of the water electrolysis catalyst is 1% or more and 20% or less by mass with respect to an added amount of the platinum or the platinum alloy as a fuel oxidation catalyst.

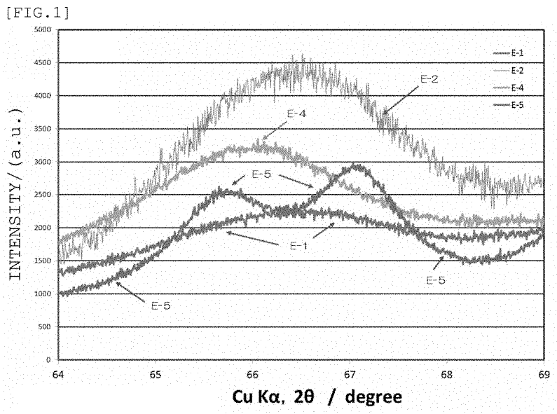

Iridium oxide (IrO₂) which is a conventionally known water electrolysis catalyst shows a (1,1,2) diffraction peak at around 2θ=66.02° as shown in FIG. 1. On the other hand, ruthenium oxide (RuO₂) shows a (1,1,2) diffraction peak around 2θ=67.05° as shown in FIG. 1. Meanwhile, the water electrolysis catalyst IrₓRu_{y}O₂ type (where x and y satisfy x+y=1.0) constituting the catalyst composition of the present embodiment preferably has a composition satisfying 0.2≤x≤0.5. The water electrolysis catalyst IrₓRu_{y}O₂ type more preferably has a composition satisfying 0.25≤x≤0.45. The solid solution complex oxide of Ir and Ru of the present embodiment has a diffraction peak at 2θ=66.10° or more and 67.00° or less. The diffraction peak is more preferably a diffraction peak at 2θ=66.15° or more and 66.95° or less. When x is less than 0.2, reverse potential durability may be insufficient, and when x exceeds 0.5, the content of iridium, which is an expensive noble metal, may be high, and this may be economically disadvantageous.

Powder X-ray diffraction is performed at 40 kV and 20 mA to 40 mA using a CuKα ray, and in the measurement of 2θ, the diffraction angle is corrected with a Si powder standard sample, and then measurement is performed in a low-speed high-resolution mode with a scan speed of 0.2° to 1.0° (2θ/min) and an angular resolution of 0.01° to 0.005°.

A method for producing a solid solution complex oxide of IrₓRu_{y}O₂ (where x and y satisfy x+y=1.0) type having a composition satisfying 0.2≤x≤0.5 as a water electrolysis catalyst in the anode catalyst composition of the present embodiment is not particularly limited, and the solid solution complex oxide can be produced, for example, by the following production method. That is, a co-solution of a trivalent iridium compound and a trivalent ruthenium compound is prepared, an alkaline compound is then reacted with the co-solution to generate fine coprecipitated fine particles of iridium-ruthenium hydroxide (IrₓRu_{y}(OH)₃; where x and y satisfy x+y=1.0), and the coprecipitated fine particles are dehydrated and oxidized in the air. A conventionally known mixed oxide of iridium oxide and ruthenium oxide is prepared by coprecipitating iridium-ruthenium hydroxide from a co-solution of a tetravalent iridium compound and a trivalent ruthenium compound, but the prepared product is a heterogeneous mixture of Ir(OH)₄ and Ru(OH)₃, and it is therefore difficult to produce a solid solution complex oxide.

The trivalent iridium compound as a starting material is not particularly limited, but for example, an iridium compound such as iridium chloride, iridium nitrate, iridium nitrosyl nitrate, or iridium acetate is suitably used. As the trivalent ruthenium compound, for example, ruthenium chloride, ruthenium nitrate, ruthenium nitrosyl nitrate, ruthenium acetate, or the like is suitably used.

As the alkaline compound to be reacted with the co-solution of the iridium compound and the ruthenium compound, for example, sodium hydroxide, potassium hydroxide, sodium carbonate, sodium hydrogen carbonate, potassium carbonate, potassium hydrogen carbonate, ammonium carbonate, ammonium hydroxide, or the like is used.

The added amount of the alkaline compound is suitably 1.2 to 3 times, preferably 1.4 to 2 times the stoichiometric amount required for the neutralization and hydroxylation of the iridium compound and the ruthenium compound.

The hydroxylation reaction with these alkaline compounds is usually carried out in an aqueous solution preferably in a temperature range of 60° C. to 95° C., more preferably 70° C. to 85° C., and preferably for 30 minutes to 10 hours, more preferably 2 hours to 5 hours. When the reaction temperature is lower than 60° C., the hydroxylation reaction rate is slow and the reaction takes a long time, and when the reaction temperature exceeds 95° C., the produced fine particles of the hydroxide are easily aggregated.

The produced coprecipitated hydroxide slurry of iridium and ruthenium is filtered and washed, then dried, and dehydrated and oxidized in the air at a temperature of preferably 300° C. to 500° C., more preferably 350° C. to 400° C., thus obtaining a solid solution complex oxide. The water electrolysis catalyst according to the present embodiment is preferably composed of a solid solution complex oxide, but may be composed of a solid solution complex oxide and a small amount of iridium-ruthenium hydroxide. When the water electrolysis catalyst according to the present embodiment contains iridium-ruthenium hydroxide, the content thereof is preferably, for example, 5 mass % or less. The water electrolysis catalyst according to the present embodiment preferably does not contain the IrO₂ phase or the RuO₂ phase.

As described above, the polymer electrolyte fuel cell is formed by using a membrane electrode assembly (MEA) in which a polymer electrolyte membrane is sandwiched between an anode catalyst layer and a cathode catalyst layer, and stacking laminates in which the membrane electrode assembly is further sandwiched between gas diffusion layers respectively provided on an anode side and a cathode side and between separators respectively provided on these sides.

In the anode catalyst layer, a catalyst, in which a catalytically active component of a noble metal such as platinum, palladium, or iridium having high fuel oxidation activity, or a catalytically active component of an alloy of platinum and a noble metal other than platinum such as gold, palladium, iridium, or ruthenium is dispersed and supported on a conductive catalyst support made of conductive carbon, conductive oxide, or the like, is generally used as a fuel oxidation catalyst. When the fuel is hydrogen, platinum is suitably used.

These fuel oxidation catalytically active components preferably have a primary particle size in a range of 1.0 nm to 10 nm, and more preferably have a primary particle size in a range of 1.5 nm to 7.0 nm. When the primary particle size is less than 1.0 nm, the mass activity increases, but elution at reverse potential is likely to occur, resulting in insufficient durability. When the primary particle size exceeds 10 nm, the utilization efficiency of the catalytically active component decreases. As a method for evaluating the primary particle size, the primary particle size is evaluated by a particle size obtained from image analysis by a high-resolution transmission electron microscope or a crystallite size obtained by powder X-ray diffraction. In the present specification, as the primary particle size of platinum as a fuel oxidation catalytically active component, a crystallite size determined from a (1,1,1) diffraction peak at around 2θ=39.8° of X-ray diffraction by the Scherrer's equation shown in (Equation 1) is used.

Scherrer's equation D=K×λ/(β×cos θ) (Equation 1)

D: Crystallite size, K: Scherrer constant, X: X-ray wavelength, P: full-width at half maximum, e: Bragg angle

On the other hand, as a primary particle size of the solid solution complex oxide of IrₓRu_{y}O₂ (where x and y satisfy x+y=1.0) as the water electrolysis catalytically active component, a crystallite size obtained from a (1,1,0) diffraction peak at around 2θ=28.0° of X-ray diffraction by the Scherrer's equation is used.

The conductive catalyst support is not particularly limited, but in order to enhance reverse potential durability, a corrosion-resistant carbon powder such as graphitized carbon black or acetylene black, or a conductive oxide powder catalyst support such as Ti₄O₇, Sb-doped SnO₂, Nb-doped SnO₂, or Ta-doped SnO₂ is suitably used. As the graphitized carbon black, a carbon black obtained by graphitizing a conductive carbon black such as Ketjen Black EC-300J (manufactured by Lion Akzo Co., Ltd.) or Vulcan XC-72R (manufactured by Cabot Corporation) at a high temperature of 1,700° C. to 2,700° C. in vacuum according to the production method of a known literature (for example, JP 5283499 B (Patent Literature 3) or JP 2006-236631 A (Patent Literature 4)) is used. As the acetylene black, a commercially available product such as DENKA BLACK (manufactured by Denka Company Limited) or SHAWINIGAN BLACK (manufactured by Chevron Phillips Chemical Company LP) is used. Among the conductive oxide catalyst support, Ti₄O₇ can be a product obtained by reducing rutile-type titania by a hydrogen reduction method (see, for example, JP 2-25994 B (Patent Literature 5) or a pulse laser method (see, for example, T. Ioroi et. al., Phys. Chem. Chem. Phy., 12, 7529 (2010) (Non Patent Literature 2)). Among the conductive oxide catalyst support, Sb-doped SnO₂, Nb-doped SnO₂, and Ta-doped SnO₂ can be used in a form of chain-like nanoparticles (see, for example, JP 5515019 B (Patent Literature 6)) produced by a flame method or a plasma method.

The specific surface area of the conductive catalyst support is preferably 50 m²/g or more and 300 m²/g or less, and more preferably 80 m²/g or more and 200 m²/g or less. When the specific surface area is less than 50 m²/g, ability to disperse and support a fuel oxidation catalytically active component such as platinum particles may be poor, and when the specific surface area exceeds 300 m²/g, corrosion resistance of the anode in a reverse potential environment may be insufficient.

A loading amount of the fuel oxidation catalytically active component on the conductive catalyst support is preferably 20 mass % to 60 mass %, and more preferably 30 mass % to 50 mass %. When the loading amount is less than 20 mass %, the anode catalyst layer may become thick and the internal resistance may increase, and when the loading amount exceeds 60 mass %, the anode catalyst layer may become too thin.

In the anode catalyst layer, the anode catalyst composition of the present embodiment, that is, a mixture of the fuel oxidation catalyst and the water electrolysis catalyst is used in a uniform dispersion mixed state.

A loading amount of the fuel oxidation catalytically active component in the anode catalyst layer is preferably in a range of 0.02 mg/cm² to 1.0 mg/cm², and particularly preferably 0.05 mg/cm² to 0.5 mg/cm² per unit area of the MEA. When the loading amount is less than 0.02 mg/cm², durability may be insufficient, and when the loading amount exceeds 1.0 mg/cm², this amount may make a cost of the catalyst increase for performance thereof.

A loading amount of the water electrolysis catalyst in the anode catalyst layer is preferably in a range of 1% to 20%, and more preferably in a range of 2% to 10% by mass with respect to the fuel oxidation catalytically active component. When the loading amount is less than 1%, reverse potential durability may be insufficient, and when the loading amount exceeds 20%, this amount may make the cost increase for the performance.

The anode catalyst layer contains a proton conductive ionomer similar to a component of the polymer electrolyte membrane in addition to the fuel oxidation catalyst and the water electrolysis catalyst. As the proton conductive ionomer, a known proton conductive ionomer can be used. The known proton conductive ionomer includes a fluorine-containing ionomer and a hydrocarbon-based ionomer not containing a fluorine atom, and as examples of the fluorine-containing ionomer, Nafion (manufactured by Dupont), Flemion (manufactured by AGC Chemicals Company), Aciplex (manufactured by Asahi Kasei Corporation), and the like can be used. As the hydrocarbon-based ionomer not containing a fluorine atom, Fumion P (manufactured by FuMA-Tech GmbH) or the like can be used.

An amount of the proton conductive ionomer in the anode catalyst layer is adjusted according to the composition of the fuel oxidation catalyst and the water electrolysis catalyst to be used. Usually, the proton conductive ionomer is preferably used at a mass ratio on a dry basis of 0.1 to 1.0 with respect to the total mass of the fuel oxidation catalyst and the water electrolysis catalyst. When the mass ratio on a dry basis is less than 0.1, the catalyst layer may have insufficient proton conductivity. When the mass ratio on a dry basis exceeds 1.0, gas diffusion may be insufficient.

A method for producing the anode catalyst layer is not particularly limited, but for example, a mixed solution of, for example, water and ethanol in a mass ratio of 1:1 is added to a catalyst powder mixture of a fuel oxidation catalyst powder and a water electrolysis catalyst powder, the mixture is uniformly mixed by ultrasonic dispersion, a dispersion of a polymer electrolyte ionomer is added to the mixture in a composition of 1:1 to 10:1 on a dry basis, more preferably in a composition of 2:1 to 5:1, the mixture is further ultrasonically dispersed to prepare an anode catalyst ink, and the anode catalyst ink is applied onto a Teflon sheet (Teflon: registered trademark) and dried to produce an anode catalyst layer sheet.

As a cathode catalyst for a polymer electrolyte fuel cell, a conventionally known electrode catalyst having high oxygen-reduction activity can be used. The most typical catalyst is a catalyst in which platinum nanoparticles are dispersed and supported on a conductive carbon catalyst support, but various contrivances have been made to reduce the used amount of platinum and improve oxygen-reduction activity and durability. For example, JP 5152942 B (Patent Literature 7) teaches a catalyst in which a platinum-cobalt-manganese ternary alloy is supported on a carbon catalyst support, JP 6125580 B (Patent Literature 8) teaches a catalyst in which a platinum ternary alloy is supported on a graphitized carbon catalyst support, and US 2007/0031722 (Patent Literature 9) teaches a catalyst in which core-shell particles composed of a shell made of platinum and a core made of palladium are supported on a carbon catalyst support. As a conductive catalyst support having high corrosion resistance, for example, graphitized carbon black, or a conductive oxide powder catalyst support such as Ti₄O₇, Sb-doped SnO₂, Nb-doped SnO₂, or Ta-doped SnO₂ is suitably used. A loading amount of catalytically active species with respect to the catalyst is 20 to 60%, more preferably 30 to 50% by mass. The cathode catalyst layer is obtained by dispersing and mixing the cathode catalyst and the proton conductive ionomer in a composition of 1:1 to 10:1 on a dry basis, more preferably in a composition of 2:1 to 5:1, and then forming the mixture into a sheet. A loading amount of the catalyst per electrode effective area is preferably 0.1 to 2 mg/cm², and more preferably 0.2 to 1 mg/cm². When the loading amount exceeds 2 mg/cm², the used amount of the noble metal increases, which is not economical. When the loading amount is less than 0.1 mg/cm², a desired performance cannot not be achieved.

A method for producing the MEA for a polymer electrolyte fuel cell is not particularly limited, and the MEA can also be produced by a method in which an anode catalyst layer is directly applied to one surface of an ion-exchange membrane and a cathode catalyst layer is directly applied to the other surface of the ion-exchange membrane, but the MEA can be preferably produced by a method (transfer method) in which an anode catalyst sheet obtained by applying an anode catalyst layer to a sheet made of polytetrafluoroethylene (Teflon (registered trademark)) and a cathode catalyst sheet obtained by applying a cathode catalyst layer to a sheet made of polytetrafluoroethylene are prepared in advance, an ion-exchange membrane is sandwiched between the catalyst sheets with the respective catalyst layers faced inward, and the membrane and the sheets are pressure-bonded by a hot press, and then the polytetrafluoroethylene sheets are peeled off.

### EXAMPLES

Hereinafter, the present disclosure will be described based on Examples. Note that the present disclosure is not limited to these Examples. In the Examples, “part” and “%” represent “part by mass” and “mass %”, respectively, unless otherwise specified.

### Example 1

### [Production of Catalyst E-1]

In a 5 L polytetrafluoroethylene beaker, iridium chloride (trivalent preparation) containing 7.19 g of iridium (IrCl₃nH₂O, manufactured by Furuya Metal Co., Ltd.) and ruthenium chloride (trivalent preparation) containing 8.82 g of ruthenium (RuCl₃nH₂O, manufactured by Furuya Metal Co., Ltd.) are placed, 2.0 L of deionized water is added thereto, the liquid temperature is raised to 80° C. while stirring, and then the mixture is stirred and held at 80° C. for 2 hours. NaOH in an amount 1.4 times the neutralization equivalent of chlorine ions of iridium chloride and ruthenium chloride is dissolved in deionized water in an amount 9 times the amount of NaOH to form a 10% NaOH solution, which is slowly added dropwise over 1.5 hours to the co-solution of iridium chloride and ruthenium chloride being stirred at 80° C. Even after completion of the dropwise addition, stirring is maintained at a liquid temperature of 80° C. for 4 hours. The produced slurry is allowed to cool to room temperature and then allowed to stand, and the supernatant is discarded by decantation. The same amount of deionized water as the amount of the removed liquid is added to the remaining slurry, the temperature is raised again to 80° C., the mixture is stirred and held at 80° C. for 1 hour, then cooled to room temperature, and allowed to stand, and the supernatant is decanted again. After the decantation washing is performed 10 times, the slurry is filtered through a membrane filter, and the cake is filtered and washed with warm water at 60° C. until the filtrate conductivity becomes less than 1 mS/m. Thereafter, the resultant is dried at 60° C. for 16 hours using an electric dryer, and then fired at 350° C. for 5 hours in an electric furnace to obtain 19.8 g of a black powder (catalyst E-1) having a composition of Ir_{0.3}Ru_{0.7}O₂.

### [Xrd Measurement]

Using a CuKα ray with an X-ray diffractometer (Ultima IV manufactured by Rigaku Corporation), at a tube voltage of 40 kV and a tube current of 40 mA, first, the diffraction angle was adjusted with an angle-standard Si powder so that the diffraction angle 2θ of Si (220) was 48.28°. The powder of the catalyst E-1 was applied to a glass substrate, and first, when the range of 2θ=10 to 90° was scanned at a sampling interval of 0.02° 2θ and a scan speed of 10° 2θ/min, the main diffraction peak was observed at 2θ=27.97°, and the crystallite size was 6.0 nm. Next, when the range of 2θ=50 to 80° was scanned in a low-speed high-resolution mode at a sampling interval of 0.005° 2θ and a scan speed of 0.2° 2θ/min, one diffraction maximum peak was detected at 2θ=66.10° or more and 67.00° or less, and the diffraction angle was 2θ=66.44°.

### Example 2

### [Production of Catalyst E-2]

The same procedure as in Example 1 was carried out except that iridium chloride (trivalent preparation) containing 9.07 g of iridium (IrCl₃nH₂O, manufactured by Furuya Metal Co., Ltd.) and ruthenium chloride (trivalent preparation) containing 7.16 g of ruthenium (RuCl₃.nH₂O, manufactured by Furuya Metal Co., Ltd.) were used, to obtain 19.7 g of a black powder (catalyst E-2) having a composition of Ir_{0.4}Ru_{0.6}O₂.

### [Xrd Measurement]

In powder X-ray diffraction of this catalyst, the crystallite size of the main diffraction peak at 2θ=27.99° was 4.4 nm, one diffraction maximum peak was observed at 2θ=66.10° or more and 67.00° or less, and the diffraction angle was 66.45°.

### Reference Example 1

### [Production of Catalyst E-3]

Carbon black Vulcan XC-72R (manufactured by Cabot Corporation) was heat-treated at 2,000° C. for 4 hours in an induction heating vacuum furnace to obtain graphitized carbon (BET specific surface area: 100 m²/g). Then, 5.0 g (on a dry basis) of the graphitized carbon was weighed and ultrasonically dispersed in 1 L of deionized water. 5.0 g of platinum black having a high specific surface area (FHPB, BET specific surface area: 85 m²/g, manufactured by Furuya Metal Co., Ltd.) was weighed as platinum, and a slurry in which the platinum black was ultrasonically dispersed in 200 ml of deionized water was added dropwise to the carbon slurry with stirring at room temperature, and the mixed slurry was still stirred for 5 hours after completion of the dropwise addition. Thereafter, the mixed slurry was filtered and washed, and dried in a vacuum dryer at 100° C. for 5 hours to obtain a 50% Pt-supported carbon catalyst (catalyst E-3).

### Comparative Example 1

### [Production of Catalyst E-4]

The same procedure as in Example 1 was carried out except that a solution of only iridium chloride containing 17.1 g of iridium was used in place of the co-solution of iridium chloride and ruthenium chloride in Example 1, and a 10% aqueous solution of NaOH for neutralizing the solution was used, to obtain 20.1 g of a black powder of IrO₂ (catalyst E-4).

### [Xrd Measurement]

The diffraction angle of the diffraction peak at around 2θ=66° to 67° in XRD of this catalyst was 66.02°, which was out of the range of 2θ=66.10° to 67.00°.

### Comparative Example 2

### [Production of Catalyst E-5]

The same procedure as in Example 1 was carried out except that a solution of only ruthenium chloride containing 15.2 g of ruthenium was used in place of the co-solution of iridium chloride and ruthenium chloride in Example 1, and a 10% aqueous solution of NaOH for neutralizing the solution was used, to obtain 19.8 g of a black powder of RuO₂ (catalyst E-5).

### [Xrd Measurement]

The diffraction angle of the diffraction peak at around 2θ=66° to 67° in XRD of this catalyst was 2θ=67.05°, which was out of the range of 2θ=66.10° to 67.000.

Table 1 shows the XRD diffraction angles 2θ of the water electrolysis catalysts of Example 1, Example 2, Comparative Example 1, and Comparative Example 2.

TABLE 1

| | | | |
|---|---|---|---|
| EXAMPLE1 | E-1 | Ir_{0.3}Ru_{0.7}O₂ | 66.44° |
| EXAMPLE2 | E-2 | Ir_{0.4}Ru_{0.6}O₂ | 66.45° |
| Comparative Example1 | E-4 | IrO₂ | 66.02° |
| Comparative Example2 | E-5 | RuO₂ | 67.05° |

### Example 3

### [Production of Anode Catalyst Sheet AS-1]

0.13 g of the powder of the catalyst E-3 of Reference Example 1 and 3.25 mg of the powder of the catalyst E-1 of Example 1 were weighed, and 1.0 g of ultrapure water, 0.48 g of 2-ethoxyethanol, 0.32 g of 2-propanol, and 0.87 g of a 5% Nafion dispersion (manufactured by Dupont) were added to the mixed powder, followed by stirring and mixing with a magnetic stirrer for 5 minutes, then with an ultrasonic disperser for 1 hour, and finally again with the magnetic stirrer for 2 hours to obtain an anode catalyst paste. A polytetrafluoroethylene sheet having a thickness of 50 μm was brought into close contact with a glass surface of a wire bar coater with a doctor blade (PM-9050MC, manufactured by SMT Co., Ltd.), the anode catalyst paste was placed onto the surface of the polytetrafluoroethylene sheet, and the blade was swept with a thickness of 0.230 mm and a sweep speed of 1.00 m/min to apply the anode catalyst paste. The wet sheet was air-dried in the air for 15 hours, and then dried at 120° C. for 3 hours using a vacuum dryer to obtain an anode catalyst sheet (AS-1). A 30 mm×30 mm rectangle was cut out with a Thomson blade and weighed, and the application amount of the catalyst per electrode area was confirmed to be 0.747 mg/cm² for E-3 and 0.020 mg/cm² for E-1. In the anode catalyst sheet AS-1, the added amount of the water electrolysis catalyst component was 5.3% by mass with respect to the added amount of platinum as the fuel oxidation catalytically active component of 0.374 mg/cm².

### Example 4

### [Production of Anode Catalyst Sheet AS-2]

An anode catalyst sheet (AS-2) was obtained by carrying out the same procedure as in Example 3 except that the catalyst E-2 of Example 2 was used in place of the catalyst E-1 of Example 1 in Example 3. The application amount of the catalyst was 0.800 mg/cm² for E-3 and 0.024 mg/cm² for E-2. In the anode catalyst sheet AS-2, the added amount of the water electrolysis catalyst component was 6.0% by mass with respect to the added amount of platinum as the fuel oxidation catalytically active component of 0.400 mg/cm².

### Comparative Example 3

### [Production of Anode Catalyst Sheet AS-3]

An anode catalyst sheet (AS-3) composed only of the fuel oxidation catalyst was obtained by carrying out the same procedure as in Example 3 except that only the catalyst E-3 of Reference Example 1 was used instead of using the catalyst E-3 of Reference Example 1 and the catalyst E-1 of Example 1.

### Comparative Example 4

### [Production of Anode Catalyst Sheet AS-4]

An anode catalyst sheet (AS-4) composed of the catalyst E-3 of Reference Example 1 and the catalyst E-4 of Comparative Example 1 was obtained in the same manner as in Example 3 except that the catalyst E-4 of Comparative Example 1 was used in place of the catalyst E-1 of Example 1.

### Comparative Example 5

### [Production of Anode Catalyst Sheet AS-5]

An anode catalyst sheet (AS-5) composed of the catalyst E-3 of Reference Example 1 and the catalyst E-5 of Comparative Example 2 was obtained in the same manner as in Example 3 except that the catalyst E-5 of Comparative Example 2 was used in place of the catalyst E-1 of Example 1.

### Reference Example 2

### [Production of Cathode Catalyst Sheet CS-1]

A cathode catalyst sheet (CS-1) was obtained in the same manner as in Example 3 except that only 0.13 g of the powder of the catalyst E-3 of Reference Example 1 was used without using the catalyst E-1 of Example 1.

### Example 5-1

### [Production of MEA]

A cation exchange membrane Nafion NRE-212 (manufactured by Dupont) was cut into 100 mm×100 mm, the cut membrane was sandwiched between the anode catalyst sheet (AS-1) produced in Example 3 and the cathode catalyst sheet (CS-1) produced in Reference Example 2 with the catalyst-applied surfaces faced inward and the centers thereof aligned, and these were pressed with a hot press (high precision hot press for MEA production, manufactured by Tester Sangyo Co., Ltd.) at 140° C. and 2 kN/cm² for 3 minutes. After taking out, the polytetrafluoroethylene sheet on the front and back surfaces was peeled off, to obtain an MEA (AS-1/CS-1) of Example 5-1.

### Example 5-2

An MEA (AS-2/CS-1) of Example 5-2 was obtained by producing an MEA in the same manner as in Example 5-1 except that the anode catalyst sheet (AS-2) produced in Example 4 was used in place of the anode catalyst sheet (AS-1) produced in Example 3.

### Comparative Example 6-1

An MEA (AS-3/CS-1) of Comparative Example 6-1 was obtained by producing an MEA in the same manner as in Example 5-1 except that the anode catalyst sheet (AS-3) produced in Comparative Example 3 was used in place of the anode catalyst sheet (AS-1) produced in Example 3.

### Comparative Example 6-2

An MEA (AS-4/CS-1) of Comparative Example 6-2 was obtained by producing an MEA in the same manner as in Example 5-1 except that the anode catalyst sheet (AS-4) produced in Comparative Example 4 was used in place of the anode catalyst sheet (AS-1) produced in Example 3.

### Comparative Example 6-3

An MEA (AS-5/CS-1) of Comparative Example 6-3 was obtained by producing an MEA in the same manner as in Example 5-1 except that the anode catalyst sheet (AS-5) produced in Comparative Example 5 was used in place of the anode catalyst sheet (AS-1) produced in Example 3.

### Example 6-1

### [Evaluation of Reverse Potential Durability of PEFC Single Cell]

A PEFC single cell (manufactured by FC Development Co, Ltd.) manufactured according to the standard cell specification of JARI (Japan Automobile Research Institute) except that the electrode effective area was 30 mm×30 mm was prepared. The MEA (AS-1/CS-1) of Example 5-1 was incorporated into a single cell, and the tightening bolt was tightened with a torque of 4 N. This single cell was connected to a gas supply line of a fuel cell evaluation apparatus (AUTO-PE, manufactured by Toyo Corporation). The reverse potential durability test was performed as follows according to the method of Non Patent Literature 1. The cell temperature was set to 40° C., hydrogen was humidified to the anode and air (Zero Air gas) was humidified to the cathode by a humidifier so as to have a dew point of 40° C., then hydrogen was supplied to the anode at a flow rate of 200 ml/min and air was supplied to the cathode at a flow rate of 600 ml/min, the fuel cell single cell was operated for 1 hour, and the initial I-V characteristics were measured. Thereafter, the anode gas was completely purged with nitrogen gas, and a current density of 0.2 A/cm² was forcibly supplied from an external power source to simulate a reverse potential state. The temporal change of the cell voltage was monitored, and the time from the start of energization at 0.2 A/cm² until the cell voltage in excess of minus 2.0 V was 21,418 seconds, which was defined as a reverse potential endurance time.

### Example 6-2

### [Evaluation of Reverse Potential Durability of PEFC Single Cell]

The reverse potential durability of the PEFC single cell was evaluated in the same manner as in Example 6-1 except that the MEA (AS-2/CS-1) of Example 5-2 was used in place of the MEA (AS-1/CS-1) of Example 5-1. The reverse potential endurance time was 24,469 seconds.

### Comparative Example 7-1

### [Evaluation of Reverse Potential Durability of PEFC Single Cell]

The reverse potential durability of the PEFC single cell was evaluated in the same manner as in Example 6-1 except that the MEA (AS-3/CS-1) of Comparative Example 6-1 was used in place of the MEA (AS-1/CS-1) of Example 5-1. The reverse potential endurance time was 1,210 seconds.

### Comparative Example 7-2

### [Evaluation of Reverse Potential Durability of PEFC Single Cell]

The reverse potential durability of the PEFC single cell was evaluated in the same manner as in Example 6-1 except that the MEA (AS-4/CS-1) of Comparative Example 6-2 was used in place of the MEA (AS-1/CS-1) of Example 5-1. The reverse potential endurance time was 16,137 seconds.

### Comparative Example 7-3

### [Evaluation of Reverse Potential Durability of PEFC Single Cell]

The reverse potential durability of the PEFC single cell was evaluated in the same manner as in Example 6-1 except that the MEA (AS-5/CS-1) of Comparative Example 6-3 was used in place of the MEA (AS-1/CS-1) of Example 5-1. The reverse potential endurance time was 6,153 seconds.

TABLE 2

| | | | | Reverse |
|---|---|---|---|---|
| | | | | potential |
| | Single cell | | | endurance time |
| | MEA | Anode | Cathode | (sec) |
| Example6-1 | MEA-1 | AS-1 (E-3 + E-1) | CS-1 (E-3) | 21,418 |
| Example6-2 | MEA-2 | AS-2 (E-3 + E-2) | CS-1 (E-3) | 24,469 |
| Comparative | MEA-3 | AS-3 (E-3) | CS-1 (E-3) | 1,210 |
| Example7-1 | | | | |
| Comparative | MEA-4 | AS-4 (E-3 + E-4) | CS-1 (E-3) | 16,137 |
| Example7-2 | | | | |
| Comparative | MEA-5 | AS-5 (E-3 + E-5) | CS-1 (E-3) | 6,153 |
| Example7-3 | | | | |

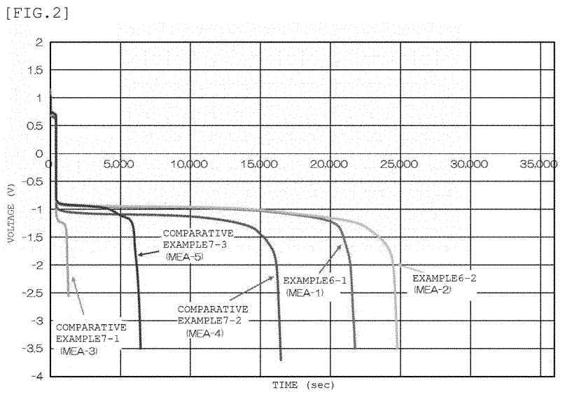

FIG. 2 shows temporal change curves of the potential of MEA single cells including various anode catalyst compositions when a reverse potential operation is performed by forcibly supplying current at a current density of 0.2 A/cm² by an external power source after switching from the normal fuel cell power generation state in which air is supplied to the cathode side and hydrogen is supplied to the anode side to the state in which air is still supplied to the cathode side and nitrogen gas is supplied to the anode side in a polymer electrolyte fuel cell single cell test (cell temperature: 40° C.). As is clear from FIG. 2, the fuel cells of the MEA-1 and the MEA-2 including an anode catalyst composition containing the water electrolysis catalyst of Examples of the present disclosure showed 10 times or more durability as compared with the MEA-3 including an anode which is composed of only the fuel oxidation catalyst and does not contain the water electrolysis catalyst. Example 6-1 and Example 6-2 showed durability at least 30% or more higher than that of Comparative Example 7-2 having the highest durability among Comparative Examples. That is, it is found that the present examples show durability at least 30% or more higher than that of the conventionally known water electrolysis catalysts such as IrO₂ and RuO₂.

What is claimed is:

1. A water electrolysis catalyst comprising a solid solution complex oxide of Ir and Ru, wherein
the solid solution complex oxide is represented by a chemical formula IrₓRu_{y}O₂ (where x and y satisfy x+y=1.0), and
the solid solution complex oxide has one diffraction maximum peak in a range of 2θ=66.10° or more and 67.00° or less in powder X-ray diffraction (Cu Kα).

2. The water electrolysis catalyst according to claim 1, wherein the solid solution complex oxide has a composition further satisfying 0.2≤x≤0.5.

3. The water electrolysis catalyst according to claim 1, wherein a (1,1,0) crystallite size of the solid solution complex oxide determined by powder X-ray diffraction (Cu Kα) is in a range of 1.0 nm to 10 nm.

4. The water electrolysis catalyst according to claim 1, wherein, in the water electrolysis catalyst, peaks derived from an IrO₂ phase and an RuO₂ phase are not observed by powder X-ray diffraction (Cu Kα).

5. The water electrolysis catalyst according to claim 1, wherein the water electrolysis catalyst contains iridium-ruthenium hydroxide.

6. An anode catalyst composition for a polymer electrolyte fuel cell, which is obtained by mixing the water electrolysis catalyst according to claim 1 and a fuel oxidation catalyst.

7. The anode catalyst composition for a polymer electrolyte fuel cell according to claim 6, wherein the fuel oxidation catalyst is a catalyst in which platinum or a platinum alloy is supported on a conductive catalyst support, and the anode catalyst composition is obtained by mixing so that an added amount of the water electrolysis catalyst is 1% or more and 20% or less by mass with respect to an added amount of the platinum or the platinum alloy.

8. The anode catalyst composition for a polymer electrolyte fuel cell according to claim 6, wherein the conductive catalyst support is a carbon powder catalyst support or a conductive oxide powder catalyst support.

9. A membrane electrode assembly (MEA) for a polymer electrolyte fuel cell, wherein a cation exchange membrane is sandwiched between a cathode catalyst layer having oxygen-reduction activity and an anode catalyst layer containing the anode catalyst composition according to claim 6.

10. The membrane electrode assembly for a polymer electrolyte fuel cell according to claim 9, wherein at least one of the cathode catalyst layer and the anode catalyst layer contains a proton conductive ionomer.
